(19) United States
(12) Patent Application Publication
(10) Pub. No.: US 2003/0230853 A1
(43) Pub. Date: Dec. 18, 2003

(54) Changeable sealing assembly for compressor apparatus

(76) Inventor: Henry C. Chu, Orange, CA (US)

Correspondence Address: CHARLES E. BAXLEY, 5th Floor, 59 John Street, New York, NY, 10038, US

(21) Appl. No.: 10/171,878

(22) Filed: Jun. 17, 2002

(51) Int. Cl. F16J 15/32

(52) U.S. Cl. 277/549

(57) ABSTRACT

A compressor includes a spindle rotatably received in a housing, and a sealing device engaged between the housing and the spindle and having a peripheral casing engaged with the housing and having a peripheral chamber for receiving a sealing ring and one or more spacers. The sealing ring will be engaged with the spindle. A spare sealing ring may be changed and engaged in the casing and engaged with the other portion of the spindle when the previous sealing ring has been worn away. Alternatively, a spare sealing device may be changeably secured onto the spindle.

### BACKGROUND OF THE INVENTION

1. Field of the Invention

The present invention relates to a compressor apparatus, and more particularly to a compressor apparatus having a changeable sealing assembly for increasing the working life of the compressor apparatus.

2. Description of the Prior Art

Various kinds of typical compressor apparatuses have been developed for the refrigerating apparatuses or the air conditioning apparatuses for vehicles. For example, U.S. Pat. No. 2,041,128 to Hirche, U.S. Pat. No. 2,738,122 to Gardiner, U.S. Pat. No. 3,080,495 to Sudmeier disclose three of the typical compressor apparatuses, and comprise a spindle rotatably received in a housing, and one or more gaskets, sealing washers, O-rings, shaft seals, etc., engaged between the housing and the spindle, for making a water tight seal between the housing and the spindle.

It is to be noted that the Compressor apparatuses are normally provided for pumping the heat media or the cooling media which may be volatile and which may include fine members or elements that are required to be sealed with precisive and perfect sealing structure. Some of the sealing devices, such as the shaft seals, comprise one or more teflon rings engaged in a housing and engaged onto the spindle, for making a fine fluid seal between the spindle and the housing.

However, the spindles of the compressor apparatuses are normally rotated in a-great speed up to thousands of rounds per second, such that a great friction may be generated or formed between the shaft seal and the spindle, and such that the shaft seal, particularly the teflon rings of the shaft seal, and/or the spindle may be worn away by the frictional engagement between the shaft seal and the spindle. The heat or cooling media may thus leak through the worn away portion between the shaft seal and the spindle.

Accordingly, the shaft seals are required to be changed or replaced with the other ones after the shaft seal, particularly the teflon rings of the shaft seal, and/or the spindle may be worn away by the frictional engagement between the shaft seal and the spindle.

However, when the spindle has been worn away by the shaft seal, and when a new shaft seal has been engaged onto the spindle, the new shaft seal will also be required to be secured onto the predetermined or previous position relative to the housing and the spindle, and the teflon rings of the new shaft seal thus will also be engaged onto the worn away portion of the spindle, such that the leaking of the heat or cooling media through the worn away portion between the shaft seal and the spindle may also be occurred.

Accordingly, the whole compressor apparatus will normally required to be discarded after the shaft seal and/or the spindle have been worn away by the frictional engagement between the shaft seal and the spindle, and after the leaking of the heat or cooling media through the worn away portion between the shaft seal and the spindle has been occurred. However, almost about ninety five percent of the elements of the compressor apparatus are still workable, but should also be discarded.

The present invention has arisen to mitigate and/or obviate the afore-described disadvantages of the conventional sealing devices for the compressor apparatuses.

### SUMMARY OF THE INVENTION

The primary objective of the present invention is to provide a compressor apparatus including a changeable sealing assembly for increasing the working life of the compressor apparatus.

In accordance with one aspect of the invention, there is provided a compressor apparatus comprising a housing including a bore formed therein, and including a peripheral opening formed therein, a spindle rotatably received in the bore of the housing, and including a peripheral area, and a sealing device received in the peripheral opening of the housing and engaged between the housing and the spindle, the sealing device including a peripheral casing received in the peripheral opening of the housing and engaged with the housing, and including a peripheral chamber formed therein, a first sealing ring received in the peripheral chamber of the housing, and engaged with the peripheral area of the spindle, at least one spacer received in the peripheral chamber of the casing, and engaged with the first sealing ring, for retaining the first sealing ring in the peripheral chamber of the casing, and for maintaining an engagement of the first sealing ring with the peripheral area of the spindle, and a second sealing ring changeably received in the peripheral chamber of the casing, and engaged with the spindle when the first sealing ring has been worn away. The spacer may be changeably engaged with the second sealing ring, for spacing the second sealing ring away from the peripheral area of the spindle, and for making a fine fluid tight seal between the spindle and the housing, without discarding the other elements or parts of the compressor apparatus. Only the worn away first sealing ring is required to be discarded, and the second sealing ring may then be engaged into and secured in the casing and engaged with the spindle at the other portions or positions other than the worn away peripheral area of the spindle, for allowing the spindle and the other parts or elements of the compressor apparatus still to be used and worked. The working life of the compressor apparatus may thus be greatly increased.

The casing includes a peripheral flange and a peripheral receptacle extended inward therefrom for forming and defining the peripheral chamber between the peripheral flange and the peripheral receptacle.

The peripheral receptacle includes an outer peripheral groove formed therein, and a ring member received in the outer peripheral groove of the peripheral receptacle and engaged between the housing and the casing.

The peripheral opening of the housing includes an inner diameter greater than that of the bore of the housing, for forming and defining a peripheral shoulder between the peripheral opening and the bore of the housing, the peripheral flange of the casing is engaged with the peripheral shoulder of the housing.

Alternatively, another or a spare sealing device may further be provided and changeably received in the peripheral opening of the housing, and changeably engaged between the housing and the spindle, and includes a sealing ring received in the peripheral chamber of the casing thereof. The sealing ring of the spare sealing device may be arranged to be engaged with the spindle and spaced away from the peripheral area of the spindle, for making a fine fluid tight seal between the spindle and the housing, without discarding the other elements or parts of the compressor apparatus. Only the sealing device is required to be changed with the other one which has a sealing ring for engaging with the other portion of the spindle.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an exploded view of a compressor apparatus having a sealing assembly in accordance with the present invention;

FIG. 2 is an enlarged partial exploded view of the compressor apparatus;

FIG. 3 is an enlarged partial cross sectional view illustrating an engagement of a shaft seal onto the spindle;

FIG. 4 is a still further enlarged partial cross sectional view illustrating the engagement of the shaft seal between the housing and the spindle;

FIG. 5 is an enlarged partial cross sectional view similar to FIG. 4, illustrating the engagement of the other shaft seal that is changeably engaged onto the spindle of the compressor apparatus; and

FIG. 6 is an enlarged partial cross sectional view similar to FIG. 4, illustrating the change and the engagement of the new sealing ring onto the spindle of the compressor apparatus.

### DETAILED DESCRIPTION OF THE PREFERRED EMBODIMENT

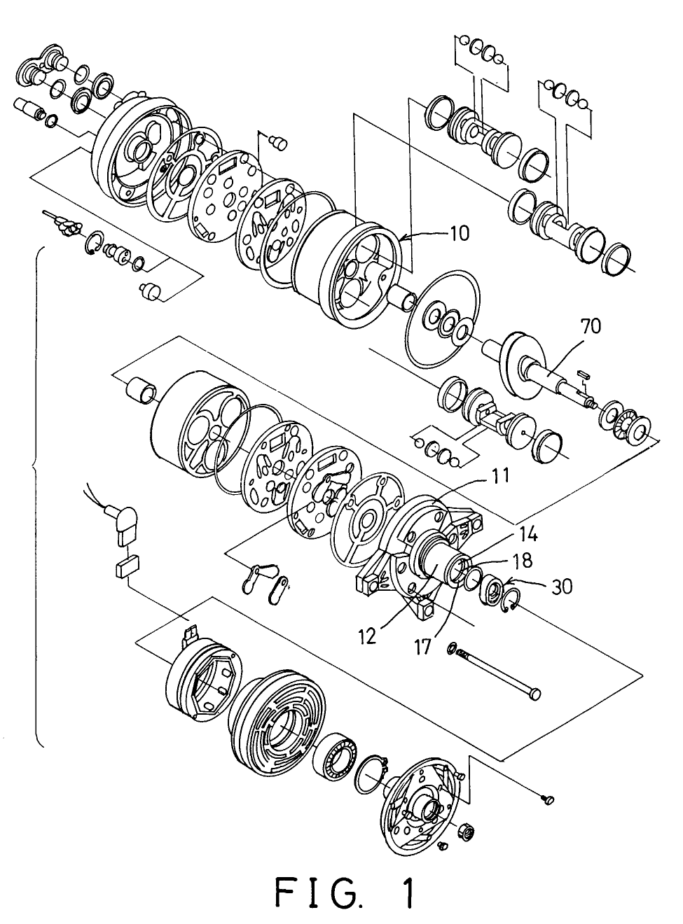

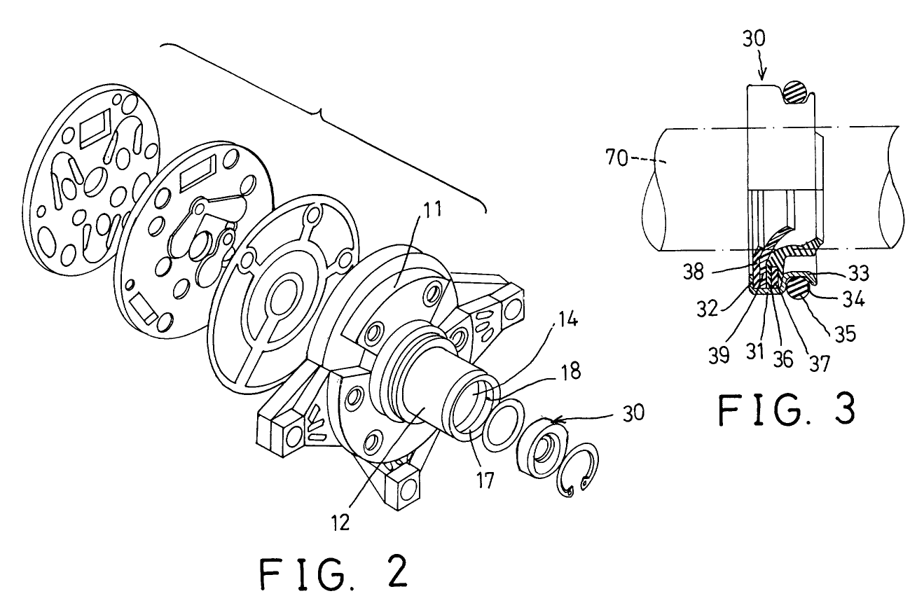

Referring to the drawings, and initially to FIGS. 1-3, a compressor apparatus in accordance with the present invention comprises a receptacle 10 for receiving various elements or parts of the typical compressor apparatus, and including one or more caps 11 attached thereto. The cap 11 may include a housing 12, such as a tubular or cylindrical housing 12 attached or provided or extended from one side thereof, and having a bore 14 formed therein for rotatably receiving a spindle 70 therein.

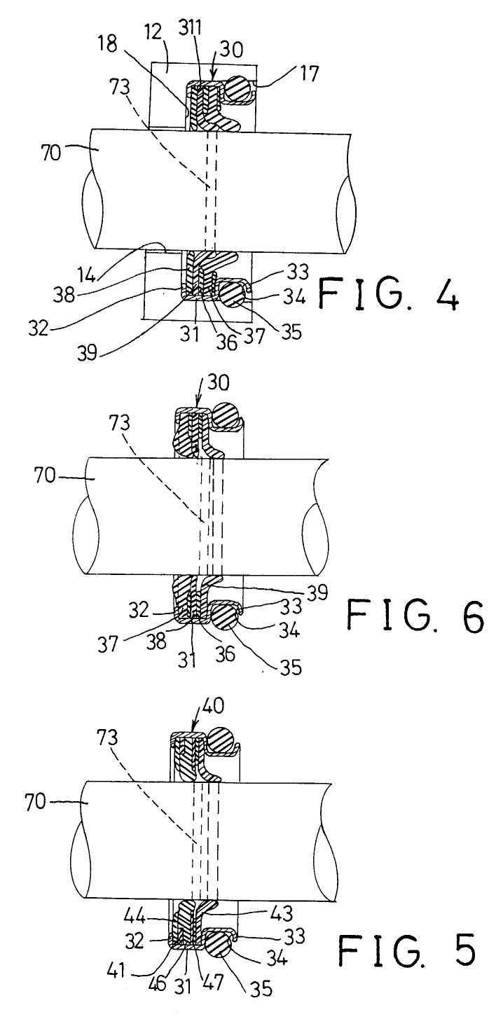

As best shown in FIGS. 4, 5, the housing 12 normally includes an enlarged peripheral opening 17 formed therein and having an inner diameter greater than that of the bore 14 thereof, for receiving shaft seals or the other sealing devices 30, 40 therein, and for forming or defining a peripheral shoulder 18 between the bore 14 and the opening 17 thereof. The sealing devices 30, 40 may be engaged between the housing 12 and the spindle 70, and may be engaged with the peripheral shoulder 18 of the housing 12, for making a fluid tight seal between the housing 12 and the spindle 70.

As shown in FIG. 4, the sealing device 30 includes a peripheral or cylindrical casing 31 having a peripheral flange 32 extended radially inward from one end thereof for engaging with the peripheral shoulder 18 of the housing 12, and includes a peripheral receptacle 33 extended radially inward from the other end thereof and having an outer peripheral groove 34 formed therein for receiving one or more sealing rings 35 therein which may be engaged between the casing 31 and the housing 12. An annular or peripheral chamber 311 may thus be formed in the casing 31, and formed or defined between the peripheral flange 32 and the peripheral receptacle 33.

One or more washers, inserts, gaskets, sealing rings, or spacers 36, 37, 38 are received in the peripheral chamber 311 of the casing 31, and a sealing ring 39, such as a teflon sealing ring 39, is further provided and also received in the peripheral chamber 311 of the casing 31 and engaged between the spacers 36, 37, 38, for allowing the spacers 36, 37, 38 and the sealing ring 39 to be solidly retained in the peripheral chamber 311 of the casing 31. The sealing ring 39 must be engaged with the spindle 70, and is the primary sealing ring 39 for making the fluid tight seal with the spindle 70.

It is to be noted that the spindle 70 is and will be rotatably secured in the housing 12 by the gaskets, and/or the sealing washers, and/or the O-rings, and/or the shaft seals, etc., which will be engaged between the spindle 70 and the housing 12 or the cap 11 or the receptacle 10, such that the spindle 70 will not and may not be moved laterally or axially relative to the housing 12, and such that the relative position between the spindle 70 and the housing 12 and the sealing device 30 is determined and may not be changed or varied.

The spindles of the compressor apparatuses are normally or also rotated in a great speed up to thousands of rounds per second, such that the sealing device 30, particularly the teflon ring or the primary sealing ring 39 of the sealing device 30, and/or the spindle 70 may be worn away by the frictional engagement between the sealing device 30 and the spindle 70. The spindle 70 may have a peripheral portion or area 73 (FIG. 4) to be worn away by the primary sealing ring 39 of the sealing device 30.

Referring next to FIG. 5, the sealing assembly of the compressor apparatus in accordance with the present invention further comprises one or more secondary or auxiliary or spare sealing devices 40 each also including a peripheral or cylindrical casing 31 having a peripheral flange 32 extended radially inward from one end thereof for engaging with the peripheral shoulder 18 of the housing 12, and includes a peripheral receptacle 33 extended radially inward from the other end thereof and having an outer peripheral groove 34 formed therein for receiving one or more sealing rings 35 therein.

An annular or peripheral chamber 41 may also be formed in the casing 31 of the sealing device 40, and formed or defined between the peripheral flange 32 and the peripheral receptacle 33. The casing 31 and the peripheral flange 32 and the peripheral receptacle 33 of the sealing device 40 are identical to that of the sealing device 30, for allowing the sealing device 40 to be changeably secured in the peripheral opening 17 of the housing 12, and to be engaged with the peripheral shoulder 18 of the housing 12, and to be snugly engaged between the housing 12 and the spindle 70.

The sealing device 40 also includes a sealing ring 43, such as a teflon sealing ring 43, which is also provided and received in the peripheral chamber 41 of the casing 31, and which must also be engaged with the spindle 70, and which is also the primary sealing ring 43 for making the fluid tight seal with the spindle 70. One or more washers, inserts, gaskets, sealing rings, or spacers 44, 46, 47 may also be further provided and received in the peripheral chamber 41 of the casing 31, and engaged with the sealing ring 43, for allowing the spacers 44, 46, 47 and the sealing ring 43 to be solidly retained in the peripheral chamber 41 of the casing 31.

It is to be noted that the spare sealing device 40, particularly the primary sealing ring 43 of the sealing device 40 may be changed to the other position relative to the casing 31, and/or the spacers 44, 46, 47 may also be changed to the other position relative to the sealing ring 43 and the casing 31, for blowing the primary sealing ring 43 of the sealing device 40 to be engaged onto the other position of the spindle 70, and to be spaced away from the worn away peripheral area 73 of the spindle 70.

Accordingly, a new primary sealing ring 43 may be engaged onto the other position of the spindle 70, and may be spaced away from the worn away peripheral area 73 of the spindle 70, such that a fine and fluid tight seal between the sealing device 40 and the spindle 70 may also be formed, and such that the compressor apparatus may still be used and worked, without discarding the whole compressor apparatus.

It is to be noted that, when the sealing ring 39 of the sealing device 30 and/or the spindle 70 has been worn away, a new primary sealing ring 43 may also be provided and engaged into the peripheral chamber 311 of the casing 31 of the sealing device 30, and the spacers 36, 37, 38 may be changed to the other position relative to the sealing ring 43 and the casing 31, such that the primary sealing ring 43 of the sealing device 30 may also be engaged onto the other position of the spindle 70, and may also be spaced away from the worn away peripheral area 73 of the spindle 70.

Only the primary sealing ring 39 of the sealing device 30 may be changed with the new primary sealing ring 43 of the sealing device 30 (FIG. 6), such that, about 99% of the compressor apparatus may still be used and worked, and need not to be discarded away.

Accordingly, the compressor apparatus in accordance with the present invention includes a changeable sealing assembly for increasing the working life of the compressor apparatus.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A compressor apparatus comprising:
a) a housing including a bore formed therein, and including a peripheral opening formed therein,
b) a spindle rotatably received in said bore of said housing, and including a peripheral area, and
c) a sealing device received in said peripheral opening of said housing and engaged between said housing and said spindle, said sealing device including:
i) a peripheral casing received in said peripheral opening of said housing and engaged with said housing, and including a peripheral chamber formed therein,
ii) a first sealing ring received in said peripheral chamber of said casing, and engaged with said peripheral area of said spindle,
iii) at least one spacer received in said peripheral chamber of said casing, and engaged with said first sealing ring, for retaining said first sealing ring in said peripheral chamber of said casing, and for maintaining an engagement of said first sealing ring with said peripheral area of said spindle, and
iv) a second sealing ring changeably received in said peripheral chamber of said casing, and engaged with said spindle when said first sealing ring has been worn away,
said at least one spacer being changeably engaged with said second sealing ring, for spacing said second sealing ring away from said peripheral area of said spindle.

2. The compressor apparatus according to claim 1, wherein said casing includes a peripheral flange and a peripheral receptacle extended inward therefrom for forming and defining said peripheral chamber between said peripheral flange and said peripheral receptacle.

3. The compressor apparatus according to claim 2, wherein said peripheral receptacle includes an outer peripheral groove formed therein, and a ring member received in said outer peripheral groove of said peripheral receptacle and engaged between said housing and said casing.

4. The compressor apparatus according to claim 2, wherein said peripheral opening of said housing includes an inner diameter greater than that of said bore of said housing, for forming and defining a peripheral shoulder between said peripheral opening and said bore of said housing, said peripheral flange of said casing is engaged with said peripheral shoulder of said housing.

5. A compressor apparatus comprising:
a) a housing including a bore formed therein, and including a peripheral opening formed therein,
b) a spindle rotatably received in said bore of said housing, and including a peripheral area,
c) a first sealing device received in said peripheral opening of said housing and engaged between said housing and said spindle, said first sealing device including:
i) a first peripheral casing received in said peripheral opening of said housing and engaged with said housing, and including a peripheral chamber formed therein,
ii) a first sealing ring received in said peripheral chamber of said first peripheral casing, and
iii) first retaining means for retaining said first sealing ring in said peripheral chamber of said first peripheral casing, to engage said first sealing ring with said peripheral area of said spindle, and
d) a second sealing device changeably received in said peripheral opening of said housing and engaged between said housing and said spindle, when said first sealing ring of said first sealing device has been worn away, said second sealing device including:
i) a second peripheral casing receivable in said peripheral opening of said housing and engageable with said housing, and including a peripheral chamber formed therein,
ii) a second sealing ring received in said peripheral chamber of said second peripheral casing, and
iii) second retaining means for retaining said second sealing ring in said peripheral chamber of said second peripheral casing, to engage said second sealing 35 ring with said spindle and spaced away from said peripheral area of said spindle.

6. The compressor apparatus according to claim 5, wherein said first and said second peripheral casings each includes a peripheral flange and a peripheral receptacle extended inward therefrom for forming and defining said peripheral chamber between said peripheral flange and said peripheral receptacle.

7. The compressor apparatus according to claim 6, wherein said peripheral receptacles of said first and said second peripheral casings each includes an outer peripheral groove formed therein, and a ring member received in said outer peripheral groove of said peripheral receptacle and changeably engaged between said housing and said first and said second peripheral casings respectively.

8. The compressor apparatus according to claim 6, wherein said peripheral opening of said housing includes an inner diameter greater than that of said bore of said housing, for forming and defining a peripheral shoulder between said peripheral opening and said bore of said housing, said peripheral flanges of said first and said second peripheral casings are changeably engaged with said peripheral shoulder of said housing.

9. The compressor apparatus according to claim 5, wherein said first retaining means includes at least one spacer received in said peripheral chamber of said first peripheral casing, and engaged with said first sealing ring, for retaining said first sealing ring in said peripheral chamber of said first peripheral casing, and for maintaining an engagement of said first sealing ring with said peripheral area of said spindle.

10. The compressor apparatus according to claim 5, wherein said second retaining means includes at least one spacer received in said peripheral chamber of said second peripheral casing, and engaged with said second sealing ring, for retaining said second sealing ring in said peripheral chamber of said second peripheral casing, to engage said second sealing ring with said spindle and spaced away from said peripheral area of said spindle.
